(19) United States
(12) Patent Application Publication
(10) Pub. No.: US 2025/0125403 A1
(43) Pub. Date: Apr. 17, 2025

(54) NICKEL-RICH CATHODE ELECTRODES WITH IONIC CONDUCTIVE ADDITIVES

(71) Applicant: GM GLOBAL TECHNOLOGY OPERATIONS LLC, Detroit, MI (US)

(72) Inventors: Mengyuan CHEN, Madison Heights, MI (US); Zhongyi LIU, Troy, MI (US); Xiaosong HUANG, Novi, MI (US)

(21) Appl. No.: 18/488,351

(22) Filed: Oct. 17, 2023

(51) Int. Cl. H01M 10/0525; H01M 4/02; H01M 4/04; H01M 4/505; H01M 4/525; H01M 4/62

(52) U.S. Cl. CPC H01M 10/0525; H01M 4/0404; H01M 4/505; H01M 4/525; H01M 4/624; H01M 2004/028

(57) ABSTRACT

A battery cell includes A anode electrodes including an anode active material layer arranged on an anode current collector, C cathode electrodes including a cathode active material layer arranged on a cathode current collector, S separators, where A, C, and S are integers, and a lithium-based electrolyte. The C cathode electrodes and the A anode electrodes exchange lithium ions. The cathode active material layer includes a cathode active material including nickel and an ionic conductive additive.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells including nickel-rich cathode electrodes with ionic conductive additives.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A battery cell includes A anode electrodes including an anode active material layer arranged on an anode current collector, C cathode electrodes including a cathode active material layer arranged on a cathode current collector, S separators, where A, C, and S are integers, and a lithium-based electrolyte. The C cathode electrodes and the A anode electrodes exchange lithium ions. The cathode active material layer includes a cathode active material including nickel and an ionic conductive additive.

In other features, the cathode active material includes Ni-rich rock salt layered oxides. The cathode active material is selected from a group consisting of LiNiₓMn_{y}Co_{1-x-y}O₂ (NMC), LiNₓCo_{y}Al_{1-x-y}O₂ (NCA), LiNiₓCo_{y}Mn_{z}Al_{1-x-y-z}O₂ (NCMA), LiNiₓMn_{y}Al_{1-x-y}O₂ (NMA), LiNiₓMn₁₋ₓO₂ (NM), LiNiO₂ (LNO), and combinations thereof. The ionic conductive additive comprises an ionic conductive precursor that is converted to an ionic conductor during cycling of the battery cell. The ionic conductive precursor is selected from a group consisting of a metal oxide, a metal phosphate, a metal fluoride, and combinations thereof.

In other features, the ionic conductive precursor includes a metal oxide selected from a group consisting of aluminum oxide (Al₂O₃), zinc oxide (ZrO₂), titanium oxide (TiO₂), diboron trioxide (B₂O₃), molybdenum trioxide (MoO₃), tungsten oxide (WO₃), tin oxide (SnO₂), and combinations thereof.

In other features, the ionic conductive precursor includes a metal phosphate selected from a group consisting of aluminum phosphate (AlPO₄), cobalt phosphate (Co₃(PO₄)₂), and combinations thereof. The ionic conductive precursor includes a metal fluoride selected from a group consisting of aluminum fluoride (AlF₃), magnesium fluoride (MgF₂), cesium fluoride (CeF₂), calcium fluoride (CaF₂), and combinations thereof.

In other features, the ionic conductive additive is selected from a group consisting of a lithium salt, a lithium nitride, a lithium hydride, a lithium halide, a perovskite, a garnet, a lithium argyrodite, a lithium superionic conductor (LISICON), a thio-LISICON, a thiophosphate, a sodium superionic conductor (NASICON), and/or combinations thereof. The ionic conductive additive comprises 0.1 wt. % to 10 wt. % of the cathode active material layer. The ionic conductive additive comprises a lithium derivative of a metal oxide, a metal phosphate, a metal fluoride, and combinations thereof.

In other features, the lithium derivative of the metal oxide is selected from a group consisting of lithium aluminate (LiAlO₂), Li₃ZrO₂, Li₂ZrO₃, Li₂O-2B₂O₃, Li₃PO₄, Li₃PO₃, Li₂WO₄, Li₃NbO₄, LiAlF₄, and combinations thereof.

In other features, a method for manufacturing a battery cell includes mixing a cathode active material, a binder, an ionic conductive precursor, and solvent to create a slurry. The cathode active material is selected from a group consisting of LiNiₓMn_{y}Co_{1-x-y}O₂ (NMC), LiNₓCo_{y}Al_{1-x-y}O₂ (NCA), LiNiₓCo_{y}Mn_{z}Al_{1-x-y-z}O₂ (NCMA), LiNiₓMn_{y}Al_{1-x-y}O₂ (NMA), LiNiₓMn₁₋ₓO₂ (NM), LiNiO₂ (LNO), and combinations thereof. The ionic conductive precursor is selected from a group consisting of a metal oxide, a metal phosphate, a metal fluoride, and combinations thereof. The method includes coating a cathode current collector with the slurry to form a cathode electrode.

In other features, the method includes arranging C of the cathode electrode, A anode electrodes including an anode active material layer arranged on an anode current collector, and S separators in an enclosure including a lithium-based electrolyte, where A, C, and S are integers. The method includes cycling the battery cell to convert the ionic conductive precursor to an ionic conductor.

In other features, the ionic conductive precursor comprises 0.1 wt. % to 10 wt. % of the cathode active material layer. The ionic conductive precursor includes the metal oxide and the metal oxide is selected from a group consisting of aluminum oxide (Al₂O₃), zinc oxide (ZrO₂), titanium oxide (TiO₂), diboron trioxide (B₂O₃), molybdenum trioxide (MoO₃), tungsten oxide (WO₃), tin oxide (SnO₂), and combinations thereof.

In other features, the ionic conductive precursor includes the metal phosphate and the metal phosphate is selected from a group consisting of aluminum phosphate (AlPO₄), cobalt phosphate (Co₃(PO₄)₂), and combinations thereof. The ionic conductive precursor includes the metal fluoride and the metal fluoride is selected from a group consisting of aluminum fluoride (AlF₃), magnesium fluoride (MgF₂), cesium fluoride (CeF₂), calcium fluoride (CaF₂), and combinations thereof.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a battery cell including anode electrodes, cathode electrodes with a nickel-rich cathode active material and an ionic conductive additive, and separators according to the present disclosure;

FIG. 2 is a more detailed view of the cathode electrode according to the present disclosure;

FIG. 3 is a graph illustrating specific capacity as a function of cycles for a battery cell including a conventional nickel-rich cathode and a nickel-rich cathode with an ionic conductive additive according to the present disclosure; and

FIGS. 4 and 5 are graphs illustrating impedance as a function of frequency for a conventional nickel-rich cathode and a nickel-rich cathode with an ionic conductive additive according to the present disclosure, respectively.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

As described above, battery cells include cathode electrodes, anode electrodes, separators, and electrolyte arranged in an enclosure. The cathode electrodes include a cathode active material layer (including cathode active material) arranged on a cathode current collector. In some examples, the cathode active material layer includes nickel-rich (Ni-rich) cathode active material, binder, and a conductive additive.

Ni-rich cathode electrodes can experience side reactions with electrolyte, transition metal ion dissolution, layer to spinel phase transformation, and/or microcrack formation. To reduce problems associated with the side reactions, the outer surface of the cathode active material is coated with a thin surface layer to improve cell cycle life. However, the coating increases cathode manufacturing complexity and energy usage.

The present disclosure relates to cathode electrodes and methods for manufacturing cathode electrodes with improved cycling stability. The cathode electrodes incorporate an ionic conductive additive and/or a precursor for an ionic conductor in a slurry mixture forming a coating for a cathode active material layer. When the ionic conductor precursor (e.g., Al₂O₃) is used, it forms a Li-conductive oxide (e.g., LiAlO₂) in-situ in the battery cell during cycling. By adding the ionic conductor precursor, the cathode electrode exhibits higher ionic conductivity and increased cycle stability. In some examples, a small amount of Al₂O₃ (e.g., 5 wt % of the cathode active material layer) is used. This approach avoids complex manufacturing steps and/or high energy usage required to surface coat the cathode active material.

The battery cells incorporating the cathode electrodes described herein have improved electrochemical performance including higher ionic conductivity and increased cycle stability. The blended ionic conductor precursor does not block electronic channels on the surfaces of the particles of the cathode active material. In contrast, since the coating covers the outer surface of the particles of the cathode active material, the coating blocks the electronic channels which reduces the energy density of the cathode electrodes.

Referring now to FIG. 1, a battery cell 10 includes C cathode electrodes 20, A anode electrodes 40, and S separators 32 arranged in a predetermined sequence in a battery cell stack 12. The battery cell stack 12 located in an enclosure 50 that includes a lithium-based electrolyte, where C, S and A are integers greater than zero. The C cathode electrodes 20-1, 20-2, . . . , and 20-C include cathode active material layers 24 arranged on one or both sides of a cathode current collector 26.

During charging/discharge, the A anode electrodes 40 and the C cathode electrodes 20 exchange lithium ions. The cathode active material layers 24 include Ni-rich cathode active material. In some examples, the cathode active material includes Ni-rich rock salt layered oxides. Examples of Ni-rich rock salt layered oxides include LiNiₓMn_{y}Co_{1-x-y}O₂ (NMC), LiNₓCo_{y}Al_{1-x-y}O₂ (NCA), LiNiₓCo_{y}Mn_{z}Al_{1-x-y-z}O₂ (NCMA), LiNiₓMn_{y}Al_{1-x-y}O₂ (NMA), LiNiₓMn₁₋ₓO₂ (NM), and LiNiO₂ (LNO).

The A anode electrodes 40-1, 40-2, . . . , and 40-A include anode active material layers 42 arranged on one or both sides of the anode current collectors 46. In some examples, the anode active material layers 42 and/or the cathode active material layers 24 comprise coatings including one or more active materials, one or more conductive additives, and/or one or more binder materials that are applied to the current collectors.

In some examples, the cathode current collector 26 and the anode current collectors 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or opposite sides of the battery cell stack 12. The external tabs 28 and 48 are connected to terminals of the battery cells.

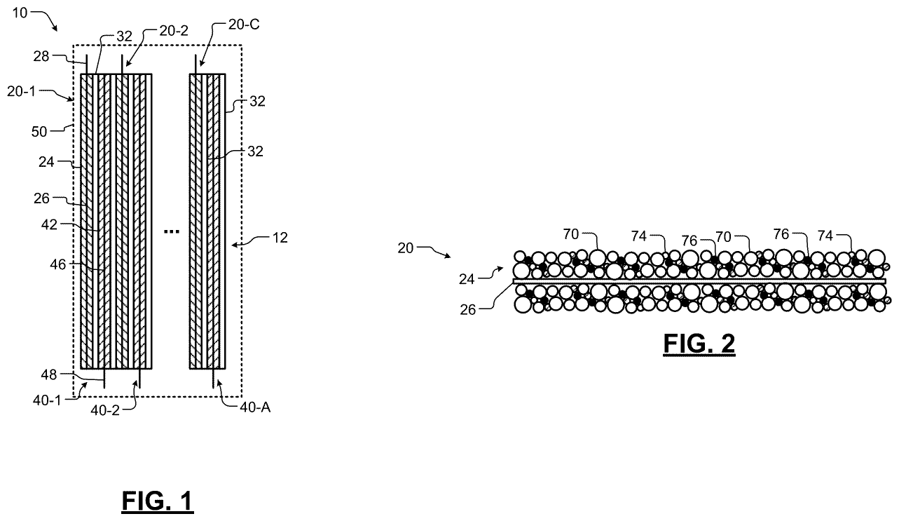

Referring now to FIG. 2, the cathode active material layer 22 is shown to include cathode active material 70, a binder 74, and a conductive additive 76. In some examples, the conductive additive 76 comprises an ionic conductive precursor or an ionic conductive additive. During manufacturing of the cathode active material layer 22, the cathode active material 70 including the Ni-rich cathode active material is blended with the binder 74, the conductive additive 76, and a solvent to create a slurry. After the slurry is deposited on the current collector, heat may be applied to remove the solvent. In some examples, the ionic conductive additive 76 comprises 0.1 wt. % to 10 wt. % of the cathode active material layer 22.

For example, an ionic conductive precursor (e.g., Al₂O₃) is added to a mixture including the Ni-rich cathode active material, the binder, and the solvent. In some examples, the mixture is mixed at a mixing speed in a range from 500 to 3000 rpm for 2 to 10 minutes. In some examples, a particle size of Al₂O₃ is in a range from 5 nm to 3 μm. In other examples, the particle size of Al₂O₃ is in a range from 0.5 μm to 3 μm.

In some examples, the cathode with the ionic conductive precursor is exposed to the electrolyte (any lithium containing electrolyte) and/or reacts with residual lithium on a surface of the cathode active material. The ionic conductive precursor is converted into an ionic conductor in-situ by electrochemical conversion when the battery cell is cycled. For example, conversion may occur when the battery cell is operated at a voltage in a range from 2.5V and 4.5V, a temperature in a range from 15° C. to 60° C., and/or a charge/discharge rate in a range from 0.01 C to 20 C.

In some examples, the conductive additive includes an ionic conductive precursor is selected from an inactive chemical including a metal oxide, a metal phosphate, and a metal fluoride that is converted to the ionic conductor during charging/discharging. Examples of metal oxides include aluminum oxide (Al₂O₃), zinc oxide (ZrO₂), titanium oxide (TiO₂), diboron trioxide (B₂O₃), molybdenum trioxide (MoO₃), tungsten oxide (WO₃), and tin oxide (SnO₂). Examples of metal phosphates include aluminum phosphate (AlPO₄), and/or cobalt phosphate (Co₃(PO₄)₂). Examples of metal fluorides include aluminum fluoride (AlF₃), magnesium fluoride (MgF₂), cesium fluoride (CeF₂), calcium fluoride (CaF₂), and combinations thereof.

In other examples, the conductive additive includes an ionic conductor comprising a lithium derivative of a metal oxide, a metal phosphate, and/or a metal fluoride. Examples of Li-derivatives of above components include lithium aluminate (LiAlO₂), Li₃ZrO₂, Li₂ZrO₃, Li₂O-2B₂O₃, Li₃PO₄, Li₃PO₃, Li₂WO₄, Li₃NbO₄, LiAlF₄, and combinations thereof.

In other examples, the conductive additive includes an ionic conductor comprising a lithium salt, a lithium nitride, a lithium halide, a lithium hydride, a perovskite, a garnet, a lithium argyrodite, a superionic conductor, and combinations thereof. Examples of lithium salts include lithium hydroxide (LiOH), lithium carbonate (Li₂CO₃), lithium nitrate (LiNO₃), lithium hexafluorophosphate (LiPF₆), and combinations thereof. An example of a perovskite includes lithium lanthanum titanate (LLTO). An example of a garnet includes lithium lanthanum zirconate (LLZO or Li₇La₃Zr₂O₁₂). An example of a lithium argyrodite includes Li₇P₃S₁₁ (LPS). An example of a superionic conductor includes a lithium superionic conductor (LISICON), a thio-LISICON, a thiophosphate, and/or a sodium superionic conductor (NASICON).

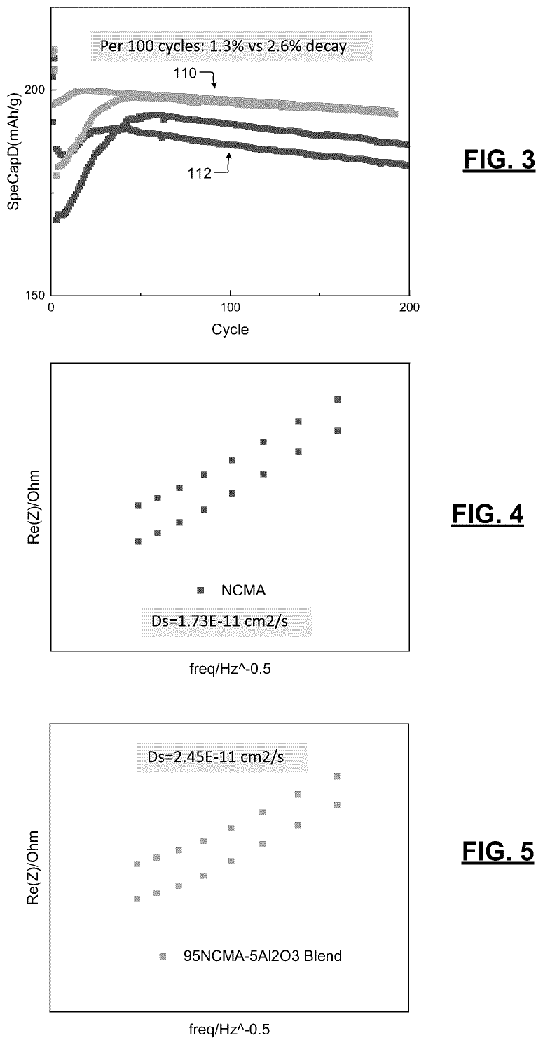

Referring now to FIG. 3, specific capacity (mAh/g) is shown as a function of cycles for a battery cell with a conventional Ni-rich cathode electrode at 110 and a battery cell with Ni-rich cathode electrodes including an ionic conductive additive at 112 according to the present disclosure. In this example, the conventional Ni-rich battery cell includes NCMA as the active material. The Ni-rich battery cells including the ionic conductive additive include a blend of NCMA (95 wt %) and Al₂O₃ (5 wt %). The specific capacity of the conventional Ni-rich battery cell declines at a rate of 2.6% per 100 cycles. The specific capacity of the Ni-rich battery cells including the ionic conductive additive declines at a rate of 1.3% per 100 cycles, which is approximately 50% less decay per 100 cycles. The specific capacity of the battery cell with conventional Ni-rich cathode electrodes is 189.1 mAh/g at 100 cycles. The specific capacity of the battery cell with Ni-rich cathode electrodes with the ionic conductive additive is 197.3 mAh/g.

Referring now to FIGS. 4 and 5, impedance is shown as a function of frequency. Ds corresponds to Li-ion diffusivity in cm²/siemens (cm²/s). Re(Z) is a measured value corresponding to the real part of EIS impedance. σ can be calculated from the second function (below), and then Ds is calculated accordingly:

$${D}_{s} = \frac{{R}^{2} {T}^{2}}{2 {A}^{2} {n}^{4} {F}^{4} {C}_{s}^{2} {σ}^{2}}$$

$$Re ( Z ) = {R}_{s} + {R}_{ct} + σ {ω}^{- \frac{1}{2}}$$

where ω is the frequency (x axis), Re(Z) is the real part of EIS impedance, R is the gas constant, Rs is cell internal contact resistance, A is the area, n is the number of electrons transferred, T is absolute temperature, F is Faraday constant, Cs is the concentration of lithium ions in solid phase, R_{ct} is charge transfer resistance, and o is the Warburg coefficient. Ds of the conventional Ni-rich battery cell is 1.73×10⁻¹¹ cm²/s. Ds of the Ni-rich battery cell with ionic conductive additives described herein is 2.45×10⁻¹¹ cm²/s. The specific capacity at 100 cycles of the conventional Ni-rich battery cell is 189.1 mAh/g. The specific capacity at 100 cycles of the Ni-rich battery cell with ionic conductive additives is 197.3 mAh/g.

The manufacturing method for the battery cells with the Ni-rich cathode electrodes and the ionic conductive additive is less complex. No extra manufacturing infrastructure is required for cathode active material coating or doping. The manufacturing method for the battery cells with the Ni-rich cathode electrodes and the ionic conductive additive uses less energy (as compared to high temperature sintering processes used in cathode active material coating or doping processes).

With the addition of a relatively small amount of the ionic conductive additive, the Ni-rich cathode electrode with the ionic conductive additive achieve higher ionic conductivity, improved cycle stability, and higher specific capacity as compared to conventional cathode electrodes with the active material (NCMA) and no ionic conductive additive.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
A anode electrodes including an anode active material layer arranged on an anode current collector;
C cathode electrodes including a cathode active material layer arranged on a cathode current collector;
S separators, where A, C, and S are integers; and
a lithium-based electrolyte,
wherein the C cathode electrodes and the A anode electrodes exchange lithium ions, and wherein the cathode active material layer includes a cathode active material including nickel and an ionic conductive additive.

2. The battery cell of claim 1, wherein the cathode active material includes Ni-rich rock salt layered oxides.

3. The battery cell of claim 1, wherein the cathode active material is selected from a group consisting of LiNiₓMn_{y}Co_{1-x-y}O₂ (NMC), LiNₓCo_{y}Al_{1-x-y}O₂ (NCA), LiNiₓCo_{y}Mn_{z}Al_{1-x-y-z}O₂ (NCMA), LiNiₓMn_{y}Al_{1-x-y}O₂ (NMA), LiNiₓMn₁₋ₓO₂ (NM), LiNiO₂ (LNO), and combinations thereof.

4. The battery cell of claim 1, wherein the ionic conductive additive comprises an ionic conductive precursor that is converted to an ionic conductor during cycling of the battery cell.

5. The battery cell of claim 4, wherein the ionic conductive precursor is selected from a group consisting of a metal oxide, a metal phosphate, a metal fluoride, and combinations thereof.

6. The battery cell of claim 4, wherein the ionic conductive precursor includes a metal oxide selected from a group consisting of aluminum oxide (Al₂O₃), zinc oxide (ZrO₂), titanium oxide (TiO₂), diboron trioxide (B₂O₃), molybdenum trioxide (MoO₃), tungsten oxide (WO₃), tin oxide (SnO₂), and combinations thereof.

7. The battery cell of claim 4, wherein the ionic conductive precursor includes a metal phosphate selected from a group consisting of aluminum phosphate (AlPO₄), cobalt phosphate (Co₃(PO₄)₂), and combinations thereof.

8. The battery cell of claim 4, wherein the ionic conductive precursor includes a metal fluoride selected from a group consisting of aluminum fluoride (AlF₃), magnesium fluoride (MgF₂), cesium fluoride (CeF₂), calcium fluoride (CaF₂), and combinations thereof.

9. The battery cell of claim 1, wherein the ionic conductive additive is selected from a group consisting of a lithium salt, a lithium nitride, a lithium hydride, a lithium halide, a perovskite, a garnet, a lithium argyrodite, a lithium superionic conductor (LISICON), a thio-LISICON, a thiophosphate, a sodium superionic conductor (NASICON), and/or combinations thereof.

10. The battery cell of claim 1, wherein the ionic conductive additive comprises 0.1 wt. % to 10 wt. % of the cathode active material layer.

11. The battery cell of claim 1, wherein the ionic conductive additive comprises a lithium derivative of a metal oxide, a metal phosphate, a metal fluoride, and combinations thereof.

12. The battery cell of claim 11, wherein the lithium derivative of the metal oxide is selected from a group consisting of lithium aluminate (LiAlO₂), Li₃ZrO₂, Li₂ZrO₃, Li₂O-2B₂O₃, Li₃PO₄, Li₃PO₃, Li₂WO₄, Li₃NbO₄, LiAlF₄, and combinations thereof.

13. A method for manufacturing a battery cell comprising:
mixing a cathode active material, a binder, an ionic conductive precursor, and solvent to create a slurry,
wherein the cathode active material is selected from a group consisting of LiNiₓMn_{y}Co_{1-x-y}O₂ (NMC), LiNₓCo_{y}Al_{1-x-y}O₂ (NCA), LiNiₓCo_{y}Mn_{z}Al_{1-x-y-z}O₂ (NCMA), LiNiₓMn_{y}Al_{1-x-y}O₂ (NMA), LiNiₓMn₁₋ₓO₂ (NM), LiNiO₂ (LNO), and combinations thereof,
wherein the ionic conductive precursor is selected from a group consisting of a metal oxide, a metal phosphate, a metal fluoride, and combinations thereof; and
coating a cathode current collector with the slurry to form a cathode electrode.

14. The method of claim 13, further comprising:
arranging C of the cathode electrode, A anode electrodes including an anode active material layer arranged on an anode current collector, and S separators in an enclosure including a lithium-based electrolyte, where A, C, and S are integers; and
cycling the battery cell to convert the ionic conductive precursor to an ionic conductor.

15. The method of claim 13, wherein the ionic conductive precursor comprises 0.1 wt. % to 10 wt. % of the cathode active material layer.

16. The method of claim 13, wherein the ionic conductive precursor includes the metal oxide and the metal oxide is selected from a group consisting of aluminum oxide (Al₂O₃), zinc oxide (ZrO₂), titanium oxide (TiO₂), diboron trioxide (B₂O₃), molybdenum trioxide (MoO₃), tungsten oxide (WO₃), tin oxide (SnO₂), and combinations thereof.

17. The method of claim 13, wherein the ionic conductive precursor includes the metal phosphate and the metal phosphate is selected from a group consisting of aluminum phosphate (AlPO₄), cobalt phosphate (Co₃(PO₄)₂), and combinations thereof.

18. The method of claim 13, wherein the ionic conductive precursor includes the metal fluoride and the metal fluoride is selected from a group consisting of aluminum fluoride (AlF₃), magnesium fluoride (MgF₂), cesium fluoride (CeF₂), calcium fluoride (CaF₂), and combinations thereof.
